(19) United States
(12) Patent Application Publication
(10) Pub. No.: US 2008/0254287 A1
(43) Pub. Date: Oct. 16, 2008

(54) SILICON CARBIDE-SILICON CARBIDE FIBER COMPOSITE AND MAKING METHOD

(76) Inventors: Hirofumi FUKUOKA, Annaka-shi (JP); Susumu Ueno, Annaka-shi (JP); Toshio Okada, Annaka-shi (JP); Meguru Kashida, Annaka-shi (JP)

Correspondence Address: BIRCH STEWART KOLASCH & BIRCH, PO BOX 747, FALLS CHURCH, VA, 22040-0747, US

(21) Appl. No.: 12/050,769

(22) Filed: Mar. 18, 2008

(30) Foreign Application Priority Data
Apr. 13, 2007 (JP) 2007-105500

(51) Int. Cl. C04B 35/565; C04B 35/52

(52) U.S. Cl. 428/368; 264/625

(57) ABSTRACT

A silicon carbide-silicon carbide fiber composite consists of silicon carbide particles and silicon carbide fibers. The composite has excellent oxidation resistance and finds a wide range of application as heat resistant material. The silicon carbide conversion method is simple and consistent enough to ensure production of silicon carbide-silicon carbide fiber composites with minimized variation in quality.

### CROSS-REFERENCE TO RELATED APPLICATION

This non-provisional application claims priority under 35 U.S.C. §119(a) on Patent Application No. 2007-105500 filed in Japan on Apr. 13, 2007, the entire contents of which are hereby incorporated by reference.

### TECHNICAL FIELD

This invention relates to silicon carbide-silicon carbide fiber composites which are applicable even in an oxidizing atmosphere as high-temperature structures, fixtures, semiconductor equipment members, liquid crystal equipment members, mechanical sliders and the like, and a method for preparing the same.

### BACKGROUND ART

Because of excellent high-temperature properties, mechanical strength and workability, graphite materials find use as a variety of high-temperature materials. However, graphite materials are less resistant to oxidation and thus limited to use in a non-oxidizing atmosphere. The high-temperature materials which can be used in an oxidizing atmosphere are oxide ceramics including silicon carbide, silicon nitride and alumina. However, these ceramics suffer from several problems including inefficient working, difficult size enlargement, and poor thermal shock resistance.

Then, for improved oxidation resistance, many attempts were made to convert graphite to silicon carbide. Several methods are known for the conversion of graphite to silicon carbide. For instance, JP-B 61-11911 discloses a method for preparing a silicon carbide-graphite composite by providing a carbon substrate in which micro-pores having a specific diameter occupy a volume of at least 0.02 cm³/g and effecting conversion using SiO gas. JP Patent 2721678 discloses a method for producing β-silicon carbide by reacting a graphite material having a bulk density of up to 1.50 g/cm³ and an average pore radius of at least 1.5 μm with SiO gas.

However, these prior art methods have several problems. The bulk density and other physical properties of graphite material are limited. Since graphite material itself has little strength, it often fails during the silicon carbide-conversion process due to a difference in coefficient of thermal expansion between graphite and silicon carbide. Thus the methods result in low yields of manufacture, which means that the resulting silicon carbide composites are expensive and have noticeable variations in quality. These production methods are thus not regarded as industrially efficient.

### DISCLOSURE OF THE INVENTION

An object of the invention is to provide a silicon carbide-silicon carbide fiber composite which is resistant to a high-temperature oxidizing atmosphere, least variant in quality, and simple and effective to prepare, and a method for preparing the same.

The inventors have found that when a carbon/carbon composite consisting of graphite particles and graphite fibers and having a high strength and brittleness is used as the graphite material, a probability of failure during the silicon carbide-conversion process is minimized, which ensures that a silicon carbide composite is readily produced. The silicon carbide composite thus produced tolerates use in a high-temperature oxidizing atmosphere.

In one aspect, the invention provides a silicon carbide-silicon carbide fiber composite consisting of silicon carbide particles and silicon carbide fibers. Preferably the composite contains 20 to 70% by weight of the silicon carbide fibers.

In another aspect, the invention provides a method for preparing a silicon carbide-silicon carbide fiber composite comprising the step of reacting a carbon/carbon composite consisting of graphite particles and graphite fibers with SiO gas at a temperature of 1100 to 1800° C. for converting graphite to silicon carbide. Preferably, the carbon/carbon composite contains 20 to 70% by weight of the graphite fibers. The reaction is typically carried out in a reduced pressure equal to or lower than 1000 Pa.

### BENEFITS OF THE INVENTION

The silicon carbide-silicon carbide fiber composite of the invention has excellent oxidation resistance and finds a wider range of various applications as heat resistant material. The silicon carbide conversion method is simple and consistent enough to ensure production of silicon carbide-silicon carbide fiber composites with minimized variation in quality and to enable efficient manufacture on an industrial scale.

### DESCRIPTION OF THE PREFERRED EMBODIMENT

The silicon carbide-silicon carbide fiber composite consists of silicon carbide particles and silicon carbide fibers. The silicon carbide particles and silicon carbide fibers are not particularly limited with respect to their physical and other properties. Where strength is required, the silicon carbide fibers are preferably present in a mixing proportion of 20 to 70% by weight, and more preferably 35 to 60% by weight of the composite. If the mixing proportion of silicon carbide fibers is less than 20% by weight, this may lead to a lower brittleness which becomes a cause of failure. If the mixing proportion of silicon carbide fibers is more than 70% by weight, this may lead to a lower strength which also becomes a cause of failure.

The shape of silicon carbide-silicon carbide fiber composite is not particularly limited and a choice of shape may be made depending on an intended application.

Now the method for preparing the silicon carbide-silicon carbide fiber composite is described. The composite can be prepared by reacting a carbon/carbon (C/C) composite consisting of graphite particles and graphite fibers with SiO gas at a temperature of 1100 to 1800° C. for converting graphite to silicon carbide.

The C/C composite from which the method starts is not particularly limited as long as it consists of graphite particles and graphite fibers. The mixing proportion of graphite particles and graphite fibers is not particularly limited as well. Where strength is required, the graphite fibers are preferably present in a mixing proportion of 20 to 70% by weight, and more preferably 35 to 60% by weight of the C/C composite. If the mixing proportion of graphite fibers is less than 20% by weight, the resulting silicon carbide-silicon carbide fiber composite contains less than 20% by weight of silicon carbide fibers, which may lead to a lower brittleness which in turn, becomes a cause of failure. If the mixing proportion of graphite fibers is more than 70% by weight, the resulting silicon carbide-silicon carbide fiber composite contains more than 70% by weight of silicon carbide fibers, which may lead to a lower strength which in turn, becomes a cause of failure.

The C/C composite may have any desired shape. In the case of plate or similar shape, the thickness is preferably 1 to 20 mm, and more preferably 3 to 15 mm. With a thickness of less than 1 mm, it may be difficult to retain the shape. If the thickness of a plate is more than 20 mm, a longer time may be necessary for its reaction with SiO gas and sometimes, the plate interior may remain unreacted.

The graphite particles preferably have an average particle size of 0.05 to 50 μm, and more preferably 0.1 to 10 μm while the shape thereof is not particularly limited. It is noted that the “average particle size” refers to a weight average value D₅₀ when the particle size distribution is determined by a laser diffraction technique, i.e., a particle size when the cumulative weight reaches 50% (also referred to as median particle size).

On the other hand, the graphite fibers preferably have a length of 1 to 500 μm, and more preferably 5 to 300 μm, and an aspect ratio (length/diameter) between 10 and 100, and more preferably between 20 and 80. The length and aspect ratio of graphite fibers may be determined by image analysis of a photomicrograph, for example, automatically computed by image analysis using a flowing particle image analyzer.

Next, the C/C composite is reacted with SiO gas at a temperature in the range of 1100° C. to 1800° C. for converting graphite to silicon carbide. It is not particularly limited how to evolve SiO gas. Typical SiO gas evolving processes are given below.

(1) Heating of SiO itself

SiO(s)→SiO(g)

(2) Heating of silica and silicon

SiO₂(s)+Si(s)→2SiO(g)

(3) Heating of silica and graphite

SiO₂(s)+C(s)→SiO(g)+CO(g)

Of these, process (2) of heating silica powder and silicon powder (e.g., fumed silica) is preferable because of high yields, moderate costs and the absence of by-products.

The treatment temperature is in the range of 1100° C. to 1800° C., and preferably 1300° C. to 1600° C. If the treatment temperature is lower than 1100° C., evolution of SiO (g) is short, resulting in insufficient reaction of SiO (g) with C/C composite. If the treatment temperature is above 1800° C., the reaction of SiO (g) with C/C composite is not significantly enhanced by more SiO (g) evolved, and the selection of furnace material is limited. As a result, an expensive furnace must be used, the furnace material may be consumed fast, or the process may not be cost effective.

The atmosphere for treatment is not particularly limited. Treatment may be carried out in an inert gas (inert to the C/C composite) such as Ar or He and under atmospheric, increased or reduced pressure and preferably under a reduced pressure because evolution of SiO (g) is promoted. The reduced pressure that ensures effective evolution of SiO (g) is specifically equal to or lower than 1000 Pa, and more specifically equal to or lower than 500 Pa. The lower limit of reduced pressure is usually at least 1 Pa though not particularly limited.

The furnace for treatment is not particularly limited as well, and a batch furnace, continuous tunnel furnace or the like may be used.

By the above treatment, a silicon carbide-silicon carbide fiber composite is obtained. To increase the purity of the composite, it may be further heat treated in an oxidizing atmosphere, typically air, for thereby removing unreacted graphite left in the composite. The temperature of the further heat treatment is preferably at least 800° C., and more preferably 850 to 1100° C.

### EXAMPLE

Examples of the invention are given below by way of illustration and not by way of limitation.

### Example 1

An alumina crucible was charged with a C/C composite plate of 100 mm×100 mm×5 mm (thick) consisting of graphite particles (average particle size 3 μm) and graphite fibers (length 200 μm, diameter 5 μm, aspect ratio 40) in a weight ratio of 1/1, and 200 g of an equimolar mixture of silicon powder with an average particle size of 5 μm and fumed silica with a BET specific surface area of 300 m²/g (Si/SiO₂=1/1 in molar ratio). The crucible was placed in a treatment furnace. The furnace was evacuated to a vacuum of 100 Pa or lower by a vacuum pump, after which it was heated and held at 1400° C. for 5 hours.

The product as treated was a green plate, which was examined by X-ray diffractometry and observed under SEM. It was identified to be a silicon carbide-silicon carbide fiber composite consisting of particles and fibers.

The silicon carbide-silicon carbide fiber composite was evaluated for oxidation resistance. It was held in air at 800° C. for 3 hours, and then cooled down. The weight was measured to find a weight loss of −0.1 wt %. A weight change of substantially zero proved it to be a fully oxidation resistant material.

### Comparative Example 1

Treatment for silicon carbide conversion was carried out as in Example 1 except that a graphite plate was used instead of the C/C composite plate. During the treatment, the graphite plate broke, failing to retain its shape.

Japanese Patent Application No. 2007-105500 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicon carbide-silicon carbide fiber composite consisting of silicon carbide particles and silicon carbide fibers.

2. The composite of claim 1, containing 20 to 70% by weight of the silicon carbide fibers.

3. A method for preparing a silicon carbide-silicon carbide fiber composite comprising reacting a carbon/carbon composite consisting of graphite particles and graphite fibers with SiO gas at a temperature of 1100 to 1800° C. for converting graphite to silicon carbide.

4. The method of claim 3 wherein the carbon/carbon composite contains 20 to 70% by weight of the graphite fibers.

5. The method of claim 3 wherein the reaction is carried out in a reduced pressure equal to or lower than 1000 Pa.
